(19) United States
(12) Patent Application Publication
(10) Pub. No.: US 2016/0326316 A1
(43) Pub. Date: Nov. 10, 2016

(54) IMPROVED POLYTETRAMETHYLENE ETHER GLYCOL MANUFACTURING PROCESS

(71) Applicant: INVISTA TECHNOLOGIES S.A.R.L., St. Gallen (CH)

(72) Inventor: Suri N. DORAI, Weston Lakes, TX (US)

(73) Assignee: INVISTA NORTH AMERICA S.A.R.L., WILMINGTON, DE (US)

(21) Appl. No.: 15/105,781

(22) PCT Filed: Dec. 19, 2014
(86) PCT No.: PCT/US2014/071522

§ 371 Date: Jun. 17, 2016

Related U.S. Application Data
(60) Provisional application No. 61/918,190, filed on Dec. 19, 2013.
(60) Provisional application No. 61/918,179, filed on Dec. 19, 2013.

(51) Int. Cl. C08G 65/20; C08G 65/30

(52) U.S. Cl. CPC C08G 65/20; C08G 65/30; C08G 2650/22

(57) ABSTRACT

The present invention relates to an improved process for manufacturing polytetramethylene ether glycol. The process involves controlling the number average molecular weight of the diacetate of polytetramethylene ether glycol intermediate produced by tetrahydrofuran polymerization before methanolysis thereof to desired polytetramethylene ether glycol product.

### CROSS-REFERENCE TO RELATED APPLICATIONS

This application claims the priority filing dates of U.S. Provisional application Ser. No. 61/918,190, filed Dec. 19, 2013 and U.S. Provisional application Ser. No. 61/918,179, filed Dec. 19, 2013, the disclosures of which are specifically incorporated herein by reference in their entireties.

### BACKGROUND OF THF INVENTION

Homopolymer of tetrahydrofuran, also known as polytetramethylene ether glycol (PTMEG), is well known for use as soft segment in polyurethanes and other elastomers. This homopolymer imparts superior dynamic properties to polyurethane elastomers and fibers.

A continuous process for converting by transesterification the diester of polytetramethylene ether (PTMEA) to the corresponding PTMEG is disclosed in U.S. Pat. No. 6,979,752.

U.S. Pat. No. 8,138,283 discloses a process for changing the given mean molecular weight in the continuous preparation of polytetrahydrofuran or tetrahydrofuran copolymers by polymerizing tetrahydrofuran in the presence of a telogen and/or of a comonomer over an acidic catalyst, in which the molar ratio of telogen to tetrahydrofuran is changed, then the mean molecular weight of at least one sample is determined during the polymerization, the polymer already formed is at least partly depolymerized over an acidic catalyst and the tetrahydrofuran recovered by depolymerization is recycled at least partly into the polymerization.

U.S. Pat. No. 5,852,218 discloses a method for converting the diacetate ester of polytetramethylene ether to a corresponding PTMEG involving reactive distillation wherein the diacetate is fed to the top portion of the distillation column along with an effective amount of at least one alkali metal oxide or alkaline earth metal oxide, hydroxide or alkoxide catalyst, feeding to the lower portion of the distillation column hot alkanol vapor to sweep any alkanol ester formed by alkanolysis of the diacetate upwardly in said distillation column; recovering overhead of the distillation column alkanol and alkanol ester formed by alkanolysis; and recovering from the bottom of the distillation column dihydroxy polyether polyol free of alkanol ester.

International Application Publication No. WO 2013/112785A1 discloses a process for converting the diacetate ester of polytetramethylene ether to the corresponding PTMEG continuously in a reaction zone, such as, for example, a reactive distillation system, for achieving virtually complete conversion of the diacetate ester to PTMEG, and recovery of PTMEG free of unreacted or unconverted diacetate ester.

European Patent No. 1433807A1 discloses a method for producing a polyether-polyol having a narrow molecular weight distribution. The method uses an aqueous solution containing from 15 to 70 wt-percent sulfuric acid.

U.S. Pat. No. 5,298,670 discloses a method of controlling molecular weight distribution of polytetramethylene ether glycol. The method relies upon the use of liquid propane as an extraction solvent to fractionate PTMEG into multiple fractions and each fraction having the polydispersity of less than about 1.3, preferably about 1.1.

U.S. Pat. No. 5,130,470 (the '470 patent) discloses polymerization of tetrahydrofuran to polytetramethylene ether glycol using a fluorinated resin containing sulfonic acid groups as the catalyst and a mixture of maleic acid and maleic anhydride as molecular weight control agent. The method of the '470 patent involves preparing dimaleate esters of polytetramethylene ether glycol segments having a molecular weight of about 600 to 4,000.

A number of publication families describe fluorosulfonic acid resins and their use as catalyst material for polymerization reactions. Among these are U.S. Pat. Appl. Pub. 2009/0118456, disclosing use of perfluorinated ion-exchange polymer containing pendant sulfonic acid and carboxylic acid groups; U.S. Pat. No. 6,040,419, disclosing use of fluorinated sulfonic acid-containing polymer containing at least 0.05 equivalents of fluorinated sulfonic acid group per kg of polymer; WO 95/19222, disclosing use of perfluorinated ion-exchange polymer containing pendant sulfonic acid and carboxylic acid groups; and U.S. Pat. No. 5,118,869, disclosing use of a blend of a fluorinated resin containing sulfonic acid groups and a fluorinated resin containing carboxylic acid groups. Likewise, U.S. Pat. No. 5,403,912 discloses use of a perfluorinated resin sulfonic acid consisting of a backbone of fluoropolymer. U.S. Pat. Appl. Pub. No. 2008/0071118 discloses use of a resin having a perfluoroalkylsulfonic acid group as a side chain in a list of possible catalysts. U.S. Pat. Appl. Pub. No. 2003/176630 discloses use of polymers comprising alpha-fluorosulfonic acids.

None of the above publications teaches a simple, economical, improved process for manufacturing polytetramethylene ether glycol by polymerization of a reaction mixture comprising tetrahydrofuran, as provided by the disclosed process.

### SUMMARY OF THF INVENTION

One aspect of the disclosed process is directed to an improved process for manufacturing polytetramethylene ether glycol comprising steps of (1) polymerizing tetrahydrofuran in the presence of an acylium ion precursor at polymerization effective conditions in a polymerization reaction zone to produce a first product mixture comprising tetrahydrofuran, acylium ion precursor, acid associated with the acylium ion precursor and diacetate of polytetramethylene ether glycol; (2) feeding the first product mixture of step (1) to a first stripping zone along with additional tetrahydrofuran to produce products comprising the diacetate and tetrahydrofuran; (3) determining the number average molecular weight of the diacetate product of step (2) by the formula: Mn=((A+B)×C)/M, wherein A is the net flow rate of acylium ion precursor to step (1), B is the sum of flow rates of tetrahydrofuran to step (1) and step (2), C is the number ratio of (2×methyl acetate molecular weight) divided by the azeotropic concentration of the methyl acetate component in M by weight; and M is the flow rate of methyl acetate azeotrope product of step (5); (4) feeding the diacetate product of step (2) to a methanolysis zone along with methanol and methanolysis catalyst to produce a second product mixture comprising methyl acetate, methanol, catalyst and polytetramethylene ether glycol; (5) feeding the second product mixture of step (4) to a second stripping zone to produce products comprising methyl acetate azeotrope and polytetramethylene ether glycol; and (6) recovering the polytetramethylene ether glycol; wherein A is adjusted to control the number average molecular weight of the diacetate product of step (2) to be from about 300 to about 2300 dalton.

Another aspect of the disclosed process is directed to improved process for manufacturing polytetramethylene ether glycol comprising steps of (1) polymerizing tetrahydrofuran in the presence of an acylium ion precursor at polymerization effective conditions in a polymerization reaction zone to produce a first product mixture comprising tetrahydrofuran, acylium ion precursor, acid associated with the acylium ion precursor and diacetate of polytetramethylene ether glycol; (2) feeding the first product mixture of step (1) to a first stripping zone along with additional tetrahydrofuran to produce products comprising the diacetate and tetrahydrofuran; (3) determining the number average molecular weight of the diacetate product of step (2) by the formula: Mn=((A+B)×N)/A, wherein A is the net flow rate of acylium ion precursor to step (1), B is the sum of flow rates of tetrahydrofuran to step (1) and step (2), and N is the theoretical stoichiometric number defined as the molecular weight of acylium ion precursor per one mole of PTMEA stoichiometry; (4) feeding the diacetate product of step (2) to a methanolysis zone along with methanol and methanolysis catalyst to produce a second product mixture comprising methyl acetate, methanol, catalyst and polytetramethylene ether glycol; (5) feeding the second product mixture of step (4) to a second stripping zone to produce products comprising methyl acetate azeotrope and polytetramethylene ether glycol; and (6) recovering the polytetramethylene ether glycol; wherein A is adjusted to control the number average molecular weight of the diacetate product of step (2) to be from about 300 to about 2300 dalton.

### BRIEF DESCRIPTION OF THF DRAWINGS

FIG. 1 is a schematic representation of a process for manufacturing PTMEG comprising a polymerization system and a methanolysis system according to embodiments of the present disclosure.

FIG. 2 is a schematic representation of an embodiment of polymerization system 105 shown in FIG. 1.

FIG. 3 is a schematic representation of an embodiment of methanolysis system 111 shown in FIG. 1.

FIG. 4 is a schematic representation of an embodiment which may be used to control the number average molecular weight (Mn) by adjusting the polymerization system 105 shown in FIG. 1.

### DETAILED DESCRIPTION OF THF INVENTION

As a result of intense research in view of the above, Applicant discovered an improved, economical process whereby Applicant can manufacture polytetramethylene ether glycol from feedstock comprising tetrahydrofuran.

The molecular weight of PTMEA, a diacetate intermediate formed during the production of PTMEG, is an important quality parameter directly linked and proportional to the molecular weight of the finished glycol product. In the process of tetrahydrofuran polymerization, amongst several process parameters the molecular weight control is primarily effected by adjusting the acylium ion precursor to a desired concentration ratio of acylium ion precursor:tetrahydrofuran in the polymerization reactor. It would be desirable and practically useful to quickly attain the target molecular weight for the finished product via proper adjustment to the acylium ion precursor concentration in the polymerization reactor.

A practical problem is that the required directional guidance on acylium ion precursor feed adjustment has a time delay in real-time before receiving molecular weight measurement response from the finished product made multiple unit operations downstream of the process. This sluggish response introduces an entire process time lag and delays the production of on-target finished product. Also, such slow process control leads to large quantities of off-target materials that the producer has to manage. These problems get worse, especially, during plant startups and/or product grade transitions such as select molecular weight grades of commercial interest.

The disclosed process solves these production problems and is particularly suitable during production plant start-ups and/or on-stream product grade transitions, wherein attaining quick steady-state production is desirable for commercial and economic reasons. Use of the disclosed process is expected to reduce the overall time to steady-state by as much as one-half or more depending on the production scale. Some economic advantages of the disclosed process are to minimize undesirable PTMEG product (e.g., with not on-target molecular weight characteristics) and the need to deal with such off-spec, transient materials. Another production advantage of the disclosed process is to eliminate the need for an intermediate storage facility to store the off-target material that would otherwise be produced from a sluggish molecular weight control which relies on the final PTMEG product molecular weight.

One aspect of the disclosed process is directed to an improved process for manufacturing polytetramethylene ether glycol comprising steps of (1) polymerizing tetrahydrofuran in the presence of an acylium ion precursor at polymerization effective conditions in a polymerization reaction zone to produce a first product mixture comprising tetrahydrofuran, acylium ion precursor, acid associated with the acylium ion precursor and diacetate of polytetramethylene ether glycol; (2) feeding the first product mixture of step (1) to a first stripping zone along with additional tetrahydrofuran to produce products comprising the diacetate and tetrahydrofuran; (3) determining the number average molecular weight of the diacetate product of step (2) by the formula: Mn=((A+B)×C)/M, wherein A is the net flow rate of acylium ion precursor to step (1), B is the sum of flow rates of tetrahydrofuran to step (1) and step (2), C is the number ratio of (2× methyl acetate molecular weight) divided by the azeotropic concentration of the methyl acetate component in M by weight; and M is the flow rate of methyl acetate azeotrope product of step (5); (4) feeding the diacetate product of step (2) to a methanolysis zone along with methanol and methanolysis catalyst to produce a second product mixture comprising methyl acetate, methanol, catalyst and polytetramethylene ether glycol; (5) feeding the second product mixture of step (4) to a second stripping zone to produce products comprising methyl acetate azeotrope and polytetramethylene ether glycol; and (6) recovering the polytetramethylene ether glycol; wherein A is adjusted to control the number average molecular weight of the diacetate product of step (2) to be from about 300 to about 2300 dalton.

Another aspect of the disclosed process is directed to an improved process for manufacturing polytetramethylene ether glycol comprising steps of (1) polymerizing tetrahydrofuran in the presence of an acylium ion precursor at polymerization effective conditions in a polymerization reaction zone to produce a first product mixture comprising tetrahydrofuran, acylium ion precursor, acid associated with the acylium ion precursor and the diacetate of polytetramethylene ether glycol; (2) feeding the first product mixture of step (1) to a first stripping zone along with additional tetrahydrofuran to produce products comprising the diacetate and tetrahydrofuran; (3) determining the number average molecular weight of the diacetate product of step (2) by the formula: Mn=((A+B)×N)/A, wherein A is the net flow rate of acylium ion precursor to step (1), B is the sum of flow rates of tetrahydrofuran to step (1) and step (2), and N is the theoretical stoichiometric number defined as the molecular weight of acylium ion precursor per one mole of PTMEA stoichiometry; (4) feeding the diacetate product of step (2) to a methanolysis zone along with methanol and methanolysis catalyst to produce a second product mixture comprising methyl acetate, methanol, catalyst and polytetramethylene ether glycol; (5) feeding the second product mixture of step (4) to a second stripping zone to produce products comprising methyl acetate azeotrope and polytetramethylene ether glycol; and (6) recovering the polytetramethylene ether glycol; wherein A is adjusted to control the number average molecular weight of the diacetate product of step (2) to be from about 300 to about 2300 dalton.

The term “PTMEG”, as used herein, unless otherwise indicated, means polytetramethylene ether glycol (CAS No. 25190-06-1). PTMEG is also known as polyoxybutylene glycol or poly(tetrahydrofuran) or PTMG. PTMEG is represented by a molecular formula; H(OCH₂CH₂CH₂CH₂)ₙOH, wherein n is a numerical value between 1 to 100.

The term “PTMEA”, as used herein, unless otherwise indicated, means the diacetate of polytetramethylene ether glycol (CAS No. 26248-69-1), also known as poly(tetramethylene ether) acetate.

The term “net flow rate of acylium ion precursor”, as used herein, means the chemically consumed acylium ion precursor flow rate in the polymerization reactor.

The THF used as a reactant in the process of the invention can be any of those commercially available. Typically, the THF has a water content of less than about 0.03% by weight and a peroxide content of less than about 0.005% by weight. If the THF contains unsaturated compounds, their concentration should be such that they do not have a detrimental effect on the polymerization process of the present invention or the polymerization product thereof. For example, for some applications it is preferred that the PTMEG product of the present invention has low API-IA color, such as, for example less than about 100 APHA units, for example, less than about 50 APHA units, e.g. less than about 20 APHA units. Optionally, the THF can contain an oxidation inhibitor such as butylated hydroxytoluene (BHT) to prevent formation of undesirable byproducts and color. If desired, one or more alkyl substituted THF's capable of copolymerizing with THF can be used as a co-reactant, in an amount from about 0.1 to about 70% by weight of the THF. Examples of such alkyl substituted THF's include 2-methyltetrahydrofuran, 3-methyltetrahydrofuran, and 3-ethyltetrahydrofuran.

In some embodiments, the acylium ion precursor for use in the process of present invention may be any compound capable of generating the acetyl oxonium ion of THF under reaction conditions. “Acylium ion”, as used herein, means an ion represented by the structure R—C⁺═O, wherein R is hydrogen or a hydrocarbon radical. Examples of the suitable hydrocarbon radical include, but are not limited to the hydrocarbon radical of 1 to 16 carbon atoms. An alkyl radical of from 1 to 16 carbon atoms is preferred.

In some embodiments, the acylium ion precursors are acetyl halides and carboxylic acid anhydrides. In other embodiments, anhydrides of carboxylic acids include carboxylic acid moieties containing from 1 to 16 carbon atoms. In some other embodiments, anhydrides of carboxylic acids include carboxylic acid moieties containing from 1 to 4 carbon atoms.

In some embodiments, the acylium ion precursors are acetic anhydride, propionic anhydride, formic-acetic anhydride and mixtures thereof. Acetic anhydride is preferred for use herein because of its ease of use and efficiency.

In one embodiment, the acylium ion precursor is present at an initial concentration of from about 0.1 to about 15% by weight. In another embodiment, the acylium ion precursor is present at an initial concentration of from about 0.2 to about 14% by weight. In yet another embodiment, the acylium ion precursor is present at an initial concentration of from about 0.3 to about 13% by weight. In a further embodiment, the acylium ion precursor is present at an initial concentration of from about 0.4 to about 12% by weight. In some other embodiment, the acylium ion precursor is present at an initial concentration of from about 0.6 to about 11% by weight.

In some embodiments, the molecular weight of the product PTMEA can be limited or controlled by the optional addition to the polymerization reaction mixture of an aliphatic carboxylic acid of form 1 to 16 carbon atoms. In other embodiments, the molecular weight of the product PTMEA can be limited or controlled by the optional addition to the polymerization reaction mixture of an aliphatic carboxylic acid of form 1 to 5 carbon atoms. Acetic acid is preferred for use herein due to its low cost and effectiveness.

In some embodiments, the acylium ion precursor/carboxylic acid weight ratio is within the range of from about 20:1 to about 0.1:1. In other embodiments, the acylium ion precursor/carboxylic acid weight ratio is within the range of from about 15:1 to about 0.2:1. In yet other embodiments, the acylium ion precursor/carboxylic acid weight ratio is within the range of from about 10:1 to about 0.5:1.

Generally speaking, the more carboxylic acid used, the lower the molecular weight of the PTMEA product. In one embodiment, the aliphatic carboxylic acid is added to the reaction mixture at a concentration of from about 0.1 to about 10% by weight of the THF. In another embodiment, the aliphatic carboxylic acid is added to the reaction mixture at a concentration of from about 0.2 to about 8% by weight of the THF. In yet another embodiment, the aliphatic carboxylic acid is added to the reaction mixture at a concentration of from about 0.3 to about 7% by weight of the THF. In a further embodiment, the aliphatic carboxylic acid is added to the reaction mixture at a concentration of from about 0.4 to about 6% by weight of the THF. In other embodiment, the aliphatic carboxylic acid is added to the reaction mixture at a concentration of from about 0.5 to about 5% by weight of the THF.

In some embodiments, separate addition of an acid for molecular weight control is unnecessary when the reaction product of THF and acetic anhydride (used as acylium ion precursor) comprises the corresponding acid (acetic acid, for example). In other embodiments, a combination of acid addition with the in-situ acid generation may be useful for the precise molecular weight control.

In some embodiments, the methanolysis catalyst comprises an acid or base chosen from H₂SO₄, HCl, alkali metal oxide, alkali metal hydroxide, alkali metal alkoxide, and combinations thereof. In other embodiments, the methanolysis catalyst comprises a base chosen from alkali metal oxide, alkali metal hydroxide or alkali metal alkoxide. Sodium methoxide (NaOMe) is preferred for use herein due to its low cost and effectiveness.

In one embodiment, the methanolysis catalyst is present in the reaction mixture at a concentration of from about 0.005 to about 0.1% by weight. In another embodiment, the methanolysis catalyst is present in the reaction mixture at a concentration of from about 0.01 to about 0.08% by weight. In a further embodiment, the methanolysis catalyst is present in the reaction mixture at a concentration of from about 0.015 to about 0.06% by weight. In yet another embodiment, the methanolysis catalyst is present in the reaction mixture at a concentration of from about 0.02 to about 0.05% by weight.

In some embodiments, the THF polymerization reaction may be conducted at a temperature of less than 100° C., from about 0° C. to about 95° C., from about 10° C. to about 90° C., from about 15° C. to about 85° C., from about 20° C. to about 80° C., preferably from about 25° C. to about 75° C., and more preferably from about 30° C. to about 70° C.

In some embodiments, the improved process further comprising steps (7) recovering the tetrahydrofuran from the first stripping zone of step (2), and (8) recycling the tetrahydrofuran recovered in step (7) to step (1).

In either the batch or continuous mode, the process is ordinarily run at atmospheric pressure, but reduced or elevated pressure may be used to aid in controlling the temperature of the reaction mixture during the reaction. In some embodiments, the process may be conducted at a pressure from about 26.7 kPa (200 mmHg) to about 106.6 kPa (800 mmHg). In other embodiments, the process may be conducted at a pressure from about 39.9 kPa (300 mmHg) to about 66.6 kPa (500 mmHg). The pressure unit, kPa, is kilopascal and 1 kPa equals 7.52 mmHg.

To avoid the formation of peroxides, the polymerization step of the present process may be conducted under an inert gas atmosphere. Non-limiting examples of suitable inert gases for use herein include nitrogen, carbon dioxide, or the noble gases, for example, helium.

The polymerization step of the present invention can also be carried out in the presence of hydrogen at hydrogen pressure of from about 10 kPa (0.1 bars) to about 1000 kPa (10 bars).

The process of the invention can be carried out in a batch mode or continuously. When run continuously, the process is preferably conducted in a back-mixed shiny reactor, with continuous stirring and with continuous addition of reactants and continuous removal of product. Alternatively, the process can be run in a pipeline reactor.

In some embodiments, the temperature in the reaction zone, the concentration of reactants in the reaction zone, and the flow rate of the reactants into and products out of the reaction zone may be adjusted to obtain about 5 to about 85% by weight of the THF per-pass conversion through the reactor. In other embodiments, the temperature in the reaction zone, the concentration of reactants in the reaction zone, and the flow rate of the reactants into and products out of the reaction zone may be adjusted to obtain about 15 to about 60% by weight of the THF per-pass conversion through the reactor. The THF per-pass conversion in the range from about 15 to about 40% by weight is preferred from an operability viewpoint.

In some embodiments, the residence time of the reactants in a continuous reactor may be maintained from about 5 minutes to about 15 hours, from about 10 minutes to about 10 hours, preferably from about 20 minutes to about 5 hours, and more preferably, from about 30 minutes to about 3 hours. The skilled in the art would know how to vary the residence time in a continuous reactor by proper adjustment of concentrations of reactants in the feed streams, of flow rates and of temperature.

In a batch reactor embodiment of the present process, THF and acylium ion precursor are placed in the reactor at appropriate reaction conditions. Polymerization can be monitored by, for example, periodic sampling and analysis. Adding a stoichiometric excess amount of chain terminator to the reaction mixture can stop polymerization.

Residence time (e.g. in minutes) is determined by measuring the volume (e.g. in milliliters) of the reaction zone and then dividing this figure by the flow rate (e.g. in milliliters per minute) of the reactants through the reactor. In a slurry reactor, the reaction zone is the entire volume of the reaction mixture; in a pipeline reactor the reaction zone is the volume occupied by the catalyst. The time required for the present improved process to provide a given conversion of THF to the diacetate of polytetramethylene ether glycol depends upon the conditions under which it is run. Time will therefore vary with temperature, pressure and concentrations of reactants; and like factors. Generally, however, in a continuous mode, the process is run to give a residence time from about 10 minutes to about 10 hours, such as from about 20 minutes to about 5 hours, for example from about 30 minutes to about 3 hours. In the batch mode, the residence time is ordinarily from about 1 to about 24 hours.

The molecular weight of the diacetate of polytetramethylene ether glycol product of step (2) can be kept within any range desired by varying the acylium ion precursor flow rate to the polymerization step of the present process, as well as by varying the concentration of any chain terminator, by varying the total amounts of any carboxylic acid and precursor in the reactant feed, by varying the temperature of the reaction mass within the above limits, and/or by controlling the residence time of the reactants in the polymerization reaction zone. Generally speaking, use of larger amounts of acylium ion precursor gives diacetate of polytetramethylene ether glycol with lower molecular weights; use of larger amounts of chain terminator gives the diacetate with lower molecular weights; lower reaction temperatures favor production of the diacetate with higher molecular weights and higher temperatures favor production of the diacetate with lower molecular weights. A commercial advantage of the present invention is that one may keep all the above variables constant, or nearly constant, while accurately controlling the molecular weight of the diacetate of polytetramethylene ether glycol product of step (2) by use of the component mass equivalency calculation for determining number average molecular weight as required herein and adjusting net flow rate of the acylium ion precursor to step (1).

In some embodiments, the net flow rate of the acylium ion precursor to step (1) is adjusted to control the number average molecular weight of the diacetate product of the polymerization system to be from about 300 dalton to about 2300 dalton, for example from about 400 dalton to about 2200 dalton, from about 500 dalton to about 2100 dalton, from about 600 dalton to about 2000 dalton. In other embodiments, the net flow rate of the acylium ion precursor to the polymerization system is adjusted to control the number average molecular weight of the diacetate product of the polymerization system to be from about 800 dalton to about 1900 dalton.

Non-limiting examples of desired number average molecular weights of the diacetate product of step (2) for important commercial applications are 885 dalton to 915 dalton material which leads to PTMEG that is used in numerous applications, and 1720 dalton to 1740 dalton material which leads to PTMEG used for manufacture of Spandex® among other valuable products.

Commercially available on-line analyzers and techniques may be used for real-time molecular weight measurements, but they are costly and present problems. Examples of these include (a) conventional Gel Permeation Chromatography (GPC)/Size-Exclusion Chromatography (SEC) with a concentration detector (for example, Refractive Index (RI), Ultraviolet (UV), Evaporative Light Scattering Detector (ELSD) and a narrow/broad/integral calibration curve constructed from matching molecular weight reference standards and materials; (b) GPC/SEC-light scattering with a concentration detector and a light scattering detector (if only a RALLS (right angle 90° laser light scattering) detector is available, in most cases a viscometer is needed to overcome the limitations of 90° light scattering (Triple detection approach)) (c) GPC/SEC-viscometry with a concentration detector and a viscometer and a universal calibration curve constructed from any molecular weight reference standards and materials; and (d) near-infrared (NIR) spectrometer. Another approach to determining only molecular weight averages is to use (batch) light scattering or (batch) osmometry. Static light scattering in batch mode needs a light scattering detector to yield reliable and precise weight average molecular weight (Mw) values. Osmometry on the other hand allows the determination of number average molecular weight (Mn) values for samples. However, without GPC/SEC on-line fractionation is missing, only molecular weight averages are available. The very important distribution information cannot be measured by this approach.

The problems of the on-line instrumentation techniques include (a) cost—the typical high installed cost of an on-line GPC varies depending on the accuracy desired; (b) sampling of a small stream for analysis—the erratic on-line sampling results in frequent shut-downs of the instrument; and (3) the on-line instruments by themselves are expensive to maintain—over and above the initial installed cost, the cost of maintenance is high. An NIR technique, for example, requires careful and time-consuming calibration to cover the component ranges in the sample matrix along with frequent fine-tuning of this calibration for reliable measurements. This is in addition to the instrument maintenance for flawless operation.

Control of the molecular weight of the diacetate of polytetramethylene ether glycol product of step (2) which in turn yields more predictable molecular weight of PTMEG final product and is desirable in commercial operation. The current determination of molecular weight of the diacetate and controlling the molecular weight of the PTMEG final product is less expensive and more reliable than using commercially available on-line analyzers. The determination comprises determining the net flow rate, for example in kg/hour, of acylium ion precursor to the step (1) reaction zone, determining the flow rate in like units of the THF to the step (1) reaction zone, determining the flow rate in like units of the additional THF to the first stripping zone, and determining the flow rate in like units of the methyl acetate azeotrope product of step 5. The number average molecular weight of the diacetate product of step (2) is then determined by using either Equation (1), Equation (2) or both as given in the Analytical Methods section. This method is universally good for all product grades, provides instant response, is accurate, and will work even when PTMEA is directed to a holding tank. Further, the flow meters available for use are very precise and reliable.

In some embodiments, the number average molecular weight of the diacetate intermediate may be determined using the Equation (1) formula when the Equation (1) parameters are obtained from the operation. In other embodiments, the number average molecular weight of the diacetate intermediate may be determined using the Equation (2) formula when the Equation (2) parameters are obtained from the operation. During an actual plant operation under transient conditions, it may not be trivial to obtain the flow rates as there are reacting components that distribute throughout the system and continue to equilibrate in various streams. A combination of component compositions along with flow rates would be required for proper molecular weight determination using either or both equations. Determination of the molecular weight using this equation method is not obvious and straight-forward.

In some embodiments, the control of molecular weight of the diacetate of polytetramethylene ether glycol may be manual. In a manually controlled system, conventional sampling methods may be implemented and the analysis result may be translated to a flow control input using a pre-determined calibration table. A board operator may manually enter the desired flow rate set point input to the flow control device and the flow device may adjust the control element using a standard PID type control action. The manual process control may be practiced repeatedly or done discretely when desired.

In other embodiments the control of molecular weight of the diacetate of polytetramethylene ether glycol may be automated using inexpensive industrial sensors, digital signal generators, data integrators and data logic processors. While the manual process control may be suitable for either batch or continuous process, the automated process control may be more advantageous for the continuous process.

Flow meters for this purpose include those commercially available, such as, for example, Vortex meters, Magmeters, etc.

The stripping zones of the present process include equipment commercially available, such as, for example, structured packed columns.

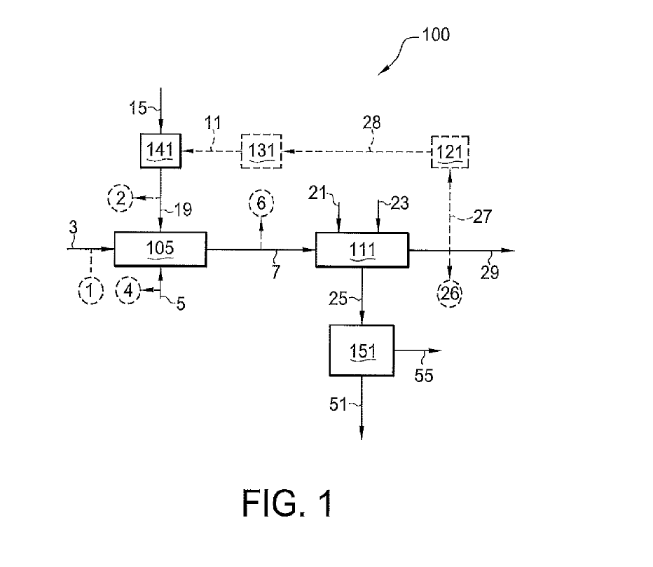

### Overview of FIG. 1

FIG. 1 is a schematic representation of a process 100 for manufacturing polytetramethylene ether glycol (PTMEG) comprising a polymerization system 105 and a methanolysis system 111 according to embodiments of the present disclosure.

Now referring to FIG. 1, stream 3 comprising tetrahydrofuran (THF) enters the polymerization system 105. The polymerization system 105 may be operated in batch or continuous mode. The acylium ion precursor is fed to the system via stream 19. A control unit 141 adjusts the flow rate of stream 15 and regulates the feed stream 19. The unit 141 may be an industrial-grade precision feed regulating device such as, but not limited to, mass flow controller, volumetric flow controller, vortex meter, magnemeter, etc. The unit 141 receives a processed input signal 11 from a process control device 131 and adjusts the feed control mechanism to deliver the demanded feed rate of stream 19 to the polymerization system 105. Stream 15 may be a pressurized feed line of the acylium ion precursor with the inlet pressure acceptable for the control unit 141.

In FIG. 1, the mass flow rates of streams 3, 5, 19, 7 and 29 are measured by the flow measurement elements 1, 4, 2, 6 and 26, respectively. The flow measurement elements may be industrial flow measurement devices that are within the process range and compatible with the streams. The mass flow rates may be measured in the units of mass per time, for example, kg/hr, kg/min, kg/sec, g/hr, g/min, g/sec, lb/hr, lb/min or lb/sec. It would be desirable to obtain all mass flowrates in the same unit of measurement.

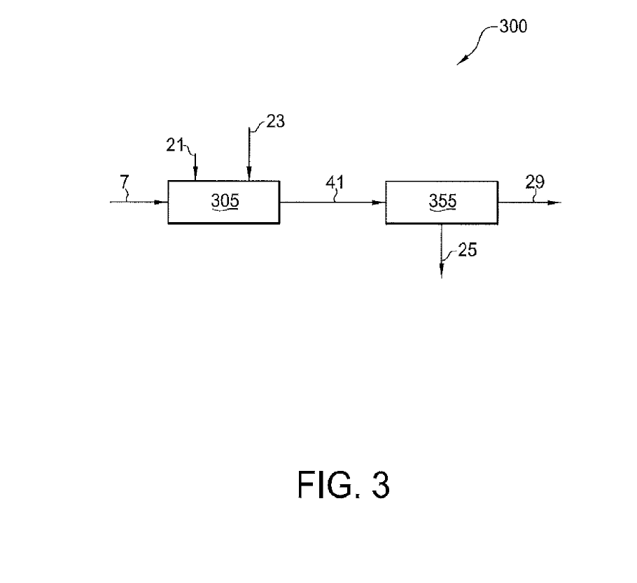

In the polymerization system 105, the polymerization conditions are maintained for THF polymerization to propagate to make a long-chain polymer in the presence of acylium ion precursor. The polymerization reactor effluent comprising PTMEA and unreacted THF is processed though a set of unit operations where the excess THF is separated, recovered and recycled. The THF material balance in the polymerization system 105 is maintained by a fresh feed of THF via stream 5. The product stream 7 out of unit 105 comprises the PTMEA with trace quantities of THF and other process by-products (for example, acetic acid). Stream 7 is taken to the methanolysis system 111 shown in FIG. 3 in detail.

A crude polytetramethylene ether glycol (PTMEG) product stream 25 is taken from the methanolysis system 111 shown in FIG. 1. The crude PTMEG stream 25 is further processed in section 151 wherein the low-molecular weight components are stripped out via stream 55. A final PTMEG product stream 51 is taken out of the section 151.

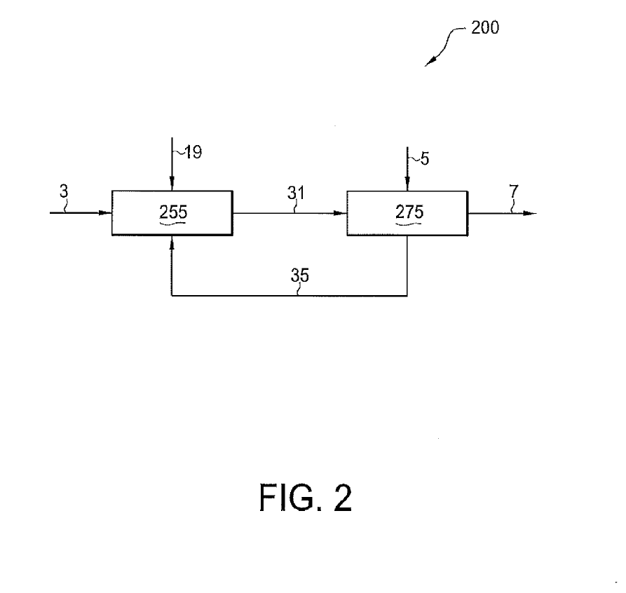

### Overview of FIG. 2

FIG. 2 is a schematic representation of an embodiment of polymerization system 105 shown in FIG. 1.

In process 200, the polymerization system comprises of two major processing steps; a polymerization reaction zone 255 and a first stripping zone 275. The effluent stream 31 from the polymerization reaction zone 255 comprising PTMEA and unreacted THF flows to the first stripping zone 275. In 275, the excess THF is removed along with other components. The crude THF stream (not shown) is further processed within zone 275 through a series of unit operations comprising distillative separations. A refined THF stream 35 of the desired purity is obtained in the first stripping zone 275 which is recycled back to the polymerization reaction zone 255 by suitable means (e.g., intermediate storage, pumps, flow lines, etc.). The THF losses in impurity purge streams (not shown) are replenished by fresh THF make-up stream 5 to the first stripping zone 275. The concentrated stream 7 comprising PTMEA serves as the feed for the next processing step.

Not shown in the figures are the auxiliary processing steps including the fresh feed tanks, hold tanks, pumps, recirculation lines, bypass lines, and metering/control devices that the skilled in the art may appreciate.

### Overview of FIG. 3

FIG. 3 is a schematic representation of an embodiment of methanolysis system 111 shown in FIG. 1.

In process 300, the methanolysis system comprises of two major processing steps; a methanolysis zone 305 and a second stripping zone 355. The concentrated PTMEA stream 7 from the previous first stripping zone (275 in FIG. 2) is fed to the methanolysis zone 305. A methanolysis catalyst stream 21 and a methanol feed stream 23 are also fed to the methanolysis zone 305. In 305, the PTMEA stream 7 is catalytically trans-esterified in the presence of excess methanol to produce PTMEG and methyl acetate. The trans-esterified stream 41 comprising the PTMEG, methyl acetate, unconverted methanol and catalyst is taken to the second stripping zone 355.

In the second stripping zone 355, the PTMEG containing stream 41 is distillatively processed to produce stream 29 comprising an azeotropic mixture of methyl acetate and methanol, and a concentrated PTMEG stream 25 along with the catalyst. The PTMEG stream 25 is further processed in a series of unit operations (section 151 in FIG. 1) to obtain the finished product stream 51 with the desired specification. The methanol-methyl acetate azeotropic stream 29 may either be separately processed via conventional distillative methods (not shown) or sold as a mixture for appropriate use.

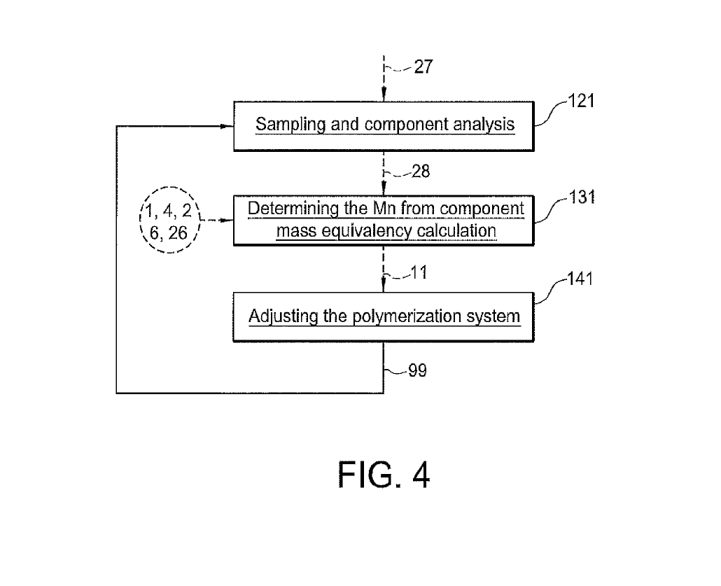

### Overview of FIG. 4

FIG. 4 is a schematic representation of an embodiment which may be used to control the Mn by adjusting the polymerization system 105 shown in FIG. 1.

Now referring to FIG. 4, a real-time sample stream 27, collected from the azeotropic mixture stream 29 (in FIG. 1 or FIG. 3), is analyzed in device 121 and the major component concentration, for example methyl acetate, in the stream is measured. The output signal 28 proportional to the measured component concentration in sample 27 is fed to a data processor 131. Optionally, the concentrated PTMEA stream 7 (in FIG. 1 or FIG. 2) may also be sampled in real-time, analyzed on-line (not shown) and the output signal may be fed to the data processor 131 for comparison.

In the data processor 131, the signal 28 is used in the component mass equivalency calculation. The other mass flow rate measurements from flow measurement elements 1, 4, 2, 6, 26 are also used to determine the Mn corresponding to the concentrated PTMEA stream 7 in FIG. 1. The output signal 11 proportional to the determined Mn is fed to the control unit 141, which compares it with the predetermined set point and the unit 141 responds in real-time to adjust the acylium ion precursor flow to the polymerization system 105 as shown in FIG. 1. This process control sequence continues in a loop manner as shown by signal 99 between the control unit 141 and device 121 via data processor 131 until the Mn setpoint is reached within its reasonable accuracy.

The device 121 may be a conventional thermal or non-thermal analytical device, such as but not limited to gas chromatograph (GC), liquid chromatograph (LC). The data processor 131 may be an industrial data processor which is capable of processing the electronic input signals and outputting the result in electronic out signals. The data processor 131 may be programmed with the control logic.

The following Examples demonstrate the present invention and its capability for use. The invention is capable of other and different embodiments, and its several details are capable of modifications in various apparent respects, without departing from the spirit and scope of the present invention. Accordingly, the Examples are to be regarded as illustrative in nature and non-limiting.

### Materials

The THF is obtained from that commercially produced by INVISTA. Table 1 gives a typical composition of INVISTA™ THF (Chemical Abstracts Registry No. 109-99-9).

TABLE 1
Specification

| | | |
|---|---|---|
| Purity (THF), % | 99.95 | max |
| Color, APHA | 10 | max. |
| Water, wt % | 0.03 | max. |
| Peroxide (calculated, as | 0.015 | max. |
| THF hydroperoxide), wt % | | |

| | |
|---|---|
| Stabilizer (BHT), ppm | 75-150 |

The acetic anhydride is purchased from Eastman Chemical. A typical composition of the acetic anhydride is 99.5% or higher by weight.

### Analytical Methods

The conversion to PTMEA is defined by the weight percent of non-volatiles in the crude product mixture collected from the reactor exit, which is measured by a vacuum oven (120° C. and about 200 mmHg) removal of the volatiles in the crude product mixture. The APHA color of the products is determined per ASTM method D 4890 using a Hunter colorimeter.

### Component Mass Equivalency Calculation

In some embodiments, the PTMEA number average molecular weight is determined by the equation below:

$${M}_{n} = \frac{[ A + B ] \times C}{M} \qquad Equation ( 1 )$$

wherein, “Mn” is the number average molecular weight, “A” is the net flow rate of acylium ion precursor [stream 19 in FIG. 2] fed to the polymerization system [255 in FIG. 2], “B” is the sum of mass flow rates of all tetrahydrofuran [sum of streams 3 and 5 in FIG. 2] fed to the polymerization system, “M” is the mass flow rate of methyl acetate azeotrope [stream 29 in FIG. 3] separated in the second stripping zone [355 in FIG. 3], and “C” is the number ratio of (2× methyl acetate molecular weight) divided by the azeotropic concentration (i.e., weight fraction) of the methyl acetate component in M. The methyl acetate molecular weight is 74.08 grams per gram-mole.

In some embodiments, the PTMEA number average molecular weight is determined by the equation below:

$${M}_{n} = \frac{[ A + B ] \times N}{A} \qquad Equation ( 2 )$$

wherein, “Mn” is the number average molecular weight, “A” is the net flow rate of acylium ion precursor [stream 19 in FIG. 2] fed to the polymerization system [255 in FIG. 2], “B” is the sum of mass flow rates of all tetrahydrofuran [sum of streams 3 and 5 in FIG. 2] fed to the polymerization system, and “N” is the theoretical stoichiometric number defined as the molecular weight of acylium ion precursor (per one mole of PTMEA stoichiometry). In other embodiments, the acylium ion precursors are acetic anhydride, propionic anhydride, formic-acetic anhydride and mixtures thereof. Acetic anhydride is preferred for use herein because of its ease of use and efficiency. The acetic anhydride molecular weight is 102.09 grams per gram-mole.

A simple substitution in Equation (1), Equation (2) or both can be considered using the overall mass balance around FIG. 2, wherein, the equation term “[A+B]” is directly substituted by the stream 7 (FIG. 2) flow rate when it is known. In FIG. 2, the overall mass balance gives, stream 7=stream 3+stream 19+stream 5. In the equations, “A” is the flow rate of stream 19, and B is the flow rate summation of stream 3 and stream 5. Therefore, the sum of “A” and “B” equals the flow rate of PTMEA (stream 7 in FIG. 2).

The flow measurement elements may be industrial flow measurement devices that are within the process range and compatible with the streams. The mass flow rates may be determined by mass flow meters, Vortex or Magmeters. All percentages are by weight unless otherwise indicated. The flow rate and compositional measurement methods, used herein, are commonly practiced in the field of chemical engineering, and the measurement errors are typically within the statistical acceptance.

### Examples 1-7

A vessel reactor [255 in FIG. 2] is charged at atmospheric pressure with THF [stream 3 in FIG. 2] at a measured flow rate and acetic anhydride (5.5 wt %) at a measured flow rate [stream 19 in FIG. 2] and heated to 45° C. A resulting product mixture [stream 31 in FIG. 2] comprising THF, acetic anhydride, acetic acid and PTMEA is then passed to a first stripping zone [275 in FIG. 2] comprising a packed column with structured stainless steel packing. A stream [7 in FIG. 2] comprising PTMEA from the first stripping zone is evaluated for molecular weight of the PTMEA by the Equation (1) formula: Mn=((A+B)×C)/M, wherein A is the net flow rate of acylium ion precursor to the reactor, B is the sum of flow rates of THF to the reactor and to the first stripping zone, “M” is the mass flow rate of methyl acetate azeotrope separated in the second stripping zone following methanolysis of the PTMEA, and “C” is calculated as below:

$$C = \frac{⌊ 2 \times molecular weight of methyl acetate ⌋}{[ weight fraction of methyl acetate component in M ]}$$

The molecular weight of methyl acetate is 74.08 grams per gram-mole. The measured weight fraction of methyl acetate component in M is about 0.78. The calculated value of C is, therefore,

$$C = \frac{⌊ 2 \times 74.08 ⌋}{[ 0.78 ]} = 189.7$$

The reaction is treated as an equilibrium polymerization. The rate constant for the THF polymerization is determined by plotting the log of (Mₒ−Mₑ)/(Mₜ−Mₑ) versus reaction time (t) where Mₒ, Mₜ and Mₑ are the THF concentrations before the reaction, at time t, and at equilibrium, respectively. In general, good linear relationships are obtained using data obtained before about 32 wt % THF conversions to PTMEA. The APHA color of the PTMEA is determined to be less than 20 APHA units.

Example 1 is repeated six times with different flow rates for the THF and acetic anhydride. Results for these experiments are provided in Table 2.

TABLE 2

| | | | | | | | | Actual Mn |
|---|---|---|---|---|---|---|---|---|
| | | | | | | | | of PTMEA |
| | | Acylium | | THF flow | | | | calculated |
| | | ion | | rate to the | Methyl | | | based on |
| | | precursor | THF flow rate | First | acetate | | | finished |
| | PTMEA | flow - | to the | stripping | azeotrope, | PTMEA | PTMEA | product |
| | flow - | kg/hr | polymerization | zone - | kg/hr | Mn | Mn | analysis |
| | kg/hr | [stream | reactor-kg/hr | kg/hr | [stream | [using | [using | [from |
| | [stream 7 | 19 in | [stream 3 in | [stream 5 | 29 in FIG. | Equation | Equation | stream 51 |
| Example | in FIG. 2] | FIG. 2] | FIG. 2] | in FIG. 2] | 3] | (1)] | (2)] | in FIG. 1] |
| 1 | 7200 | 860 | 5188 | 1152 | 1599 | 854 | 855 | 862 |
| 2 | 7200 | 820 | 5228 | 1152 | 1524 | 896 | 896 | 892 |
| 3 | 4000 | 450 | 2910 | 640 | 837 | 907 | 907 | 895 |
| 4 | 6400 | 400 | 4976 | 1024 | 744 | 1632 | 1633 | 1648 |
| 5 | 6400 | 380 | 4996 | 1024 | 707 | 1718 | 1719 | 1715 |
| 6 | 3900 | 230 | 3046 | 624 | 428 | 1730 | 1731 | 1732 |
| 7 | 6400 | 345 | 5031 | 1024 | 642 | 1892 | 1894 | 1895 |

In FIG. 2, the overall mass balance gives, stream 7=stream 3+stream 19+stream 5. Accordingly, in Table 2, the first column labeled “PTMEA Flow” is the sum of the three columns that follow and labeled as “Acylium ion precursor flow”, “THF flow rate to the polymerization reactor” and “THF flow rate to the first stripping zone”. When the PTMEA flow rate (stream 7 in FIG. 2) is known, it would replace the “[A+B]” term in either equation.

The data in Table 2 indicate that an early determination of the number average molecular weight of the PTMEA intermediate contained in stream 7 of FIG. 1 using the disclosed method, which is directly linked and proportional to the molecular weight of PTMEG final product stream 51 in FIG. 1, is extremely important in commercial operation, and can effectively be controlled by adjusting flow rate of acylium ion precursor [stream 19 in FIG. 1] to polymerization reaction zone [105 in FIG. 1]. This is accomplished by way of feed forward control via Equation (1) and/or Equation (2) given above.

As an illustration, in Example 5 of Table 2, “A” is equal to 380 kg/hr, B is equal to 6020 kg/hr (4996+1024), “C” is previously calculated to be 189.7, “M” is equal to 706.7 kg/hr, and “N” is equal to 102.09 grams per gram-mole of acetic anhydride per molar PTMEA production. Acetic anhydride is used in this example as an acylium ion precursor.

$$Equation ( 1 ) gives , {M}_{n} = \frac{[ 380 + 6020 ] \times 189.7}{706.7} = 1718$$

$$Equation ( 2 ) gives , {M}_{n} = \frac{[ 380 + 6020 ] \times 102.09}{380} = 1719$$

The actual number average molecular weight (Mn) of PTMEA obtained based on the finished product analysis [from stream 51 in FIG. 1] is 1715, as given in the last column of Table 2.

### Examples 8-14

Each of the PTMEA products [stream 7 in FIG. 3] of the experiments of Examples 1 through 7 is fed to a methanolysis zone [305 in FIG. 3] along with methanol [stream 23 in FIG. 3] and NaOMe methanolysis catalyst [stream 21 in FIG. 3] to produce a product mixture. The PTMEA stream from the polymerization process is continuously mixed with methanol 20-30% by weight and NaOMe 0.02 to 0.05% by weight in a reactive distillation column for methanolysis to completely convert PTMEA to PTMEG. The products of the methanolysis [stream 41 in FIG. 3] are fed to a second stripping zone [355 in FIG. 3] comprising a packed column with structured stainless steel packing to produce products comprising methyl acetate azeotrope stream 29 in FIG. 3 (comprising 78-79% methyl acetate) and PTMEG stream 25 in FIG. 3. The flow rate of the methyl acetate azeotrope is determined for each experiment. The final PTMEG product [stream 51 in FIG. 1] resulting from each experiment is recovered [using 151 in FIG. 1] and its molecular weight is determined. Table 3 shows the relation between the calculated number average molecular weights of the PTMEA intermediate, contained in stream 7 of FIG. 2, for the Example 1 through 7 experiments to the molecular weights of the final PTMEG products [i.e., stream 51 in FIG. 1] of the Example 8 through 14 experiments.

TABLE 3

| | PTMEA Mn | PTMEA Mn | PTMEG |
|---|---|---|---|
| Example | using Equation | using Equation | Molecular |
| # | (1) - Table 2 | (2) - Table 2 | Weight (Mn) |
| 8 | 854 | 855 | 954 |
| 9 | 896 | 896 | 992 |
| 10 | 907 | 907 | 1005 |
| 11 | 1632 | 1633 | 1704 |
| 12 | 1718 | 1719 | 1762 |
| 13 | 1730 | 1731 | 1801 |
| 14 | 1892 | 1894 | 1998 |

The above data confirms that the present invention provides an improved process for manufacturing PTMEG with controllable and desirable properties. An early determination of the PTMEA molecular weight at the process upstream and precious control thereof by adjusting the acylium ion precursor feed rate to the polymerization reactor produces the final PTMEG product with on-target molecular weight. The data in Table 3 confirm a direct proportionality between the PTMEA molecular weight and final PTMEG product molecular weight.

While the illustrative embodiments of the invention have been described with particularity, it will be understood that various other modifications will be apparent to and may be readily made by those skilled in the art without departing from the spirit and scope of the invention.

Accordingly, it is not intended that the scope of the claims hereof be limited to the examples and descriptions set forth herein but rather that the claims be construed as encompassing all the features of patentable novelty which reside in the present invention, including all features which would be treated as equivalents thereof by those skilled in the art to which the invention pertains.

What is claimed is:

1. An improved process for manufacturing polytetramethylene ether glycol comprising steps of (1) polymerizing tetrahydrofuran in the presence of an acylium ion precursor at polymerization effective conditions in a polymerization reaction zone to produce a first product mixture comprising tetrahydrofuran, acylium ion precursor, acid associated with the acylium ion precursor and diacetate of polytetramethylene ether glycol; (2) feeding the first product mixture of step (1) to a first stripping zone along with additional tetrahydrofuran to produce products comprising the diacetate and tetrahydrofuran; (3) determining the number average molecular weight of the diacetate product of step (2) by the formula: Mn=((A+B)×C)/M, wherein A is the net flow rate of acylium ion precursor to step (1), B is the sum of flow rates of tetrahydrofuran to step (1) and step (2), C is the number ratio of (2× methyl acetate molecular weight) divided by the azeotropic concentration of the methyl acetate component in M by weight; and M is the flow rate of methyl acetate azeotrope product of step (5); (4) feeding the diacetate product of step (2) to a methanolysis zone along with methanol and methanolysis catalyst to produce a second product mixture comprising methyl acetate, methanol, catalyst and polytetramethylene ether glycol; (5) feeding the second product mixture of step (4) to a second stripping zone to produce products comprising methyl acetate azeotrope and polytetramethylene ether glycol; and (6) recovering the polytetramethylene ether glycol; wherein A is adjusted to control the number average molecular weight of the diacetate product of step (2) to be from about 300 to about 2300 dalton.

2. The process of claim 1 wherein the number average molecular weight of the diacetate product of step (2) is controlled to be from about 800 to about 1900 dalton.

3. The process of claim 1 wherein the acylium ion precursor is selected from the group consisting of acetyl halides, carboxylic acid anhydrides and combinations thereof.

4. The process of claim 3 wherein the acylium ion precursor is acetic anhydride.

5. The process of claim 1 comprising steps (7) recovering the tetrahydrofuran from the first stripping zone of step (2), and (8) recycling the tetrahydrofuran recovered in step (7) to step (1).

6. The process of claim 1 wherein the polymerization effective conditions include a temperature of from about 0° C. to about 80° C.

7. The process of claim 6 wherein the polymerization effective conditions include a pressure from about 200 to about 800 mmHg.

8. The process of claim 6 in continuous mode wherein the polymerization effective conditions include a residence time from about 10 minutes to about 10 hours.

9. The process of claim 6 in batch mode wherein the polymerization effective conditions include a residence time from about 1 to about 24 hours.

10. The process of claim 6 wherein the acylium ion precursor is acetic anhydride and the acid associated with the acylium ion precursor is acetic acid.

11. The process of claim 1 wherein the catalyst of step (4) comprises an acid or base selected for the group consisting of H₂SO₄, HCl, alkali metal oxide, alkali metal hydroxide, alkali metal alkoxide, and combinations thereof.

12. An improved process for manufacturing polytetramethylene ether glycol comprising steps of (1) polymerizing tetrahydrofuran in the presence of an acetic anhydride at polymerization effective conditions in a polymerization reaction zone to produce a product mixture comprising tetrahydrofuran, acetic anhydride, acetic acid and diacetate of polytetramethylene ether glycol; (2) feeding the first product mixture of step (1) to a first stripping zone along with additional tetrahydrofuran to produce products comprising the diacetate and tetrahydrofuran; (3) determining the number average molecular weight of the diacetate product of step (2) by the formula: Mn=((A+B)×C)/M, wherein A is the net flow rate of acetic anhydride to step (1), B is the sum of flow rates of tetrahydrofuran to step (1) and step (2), C is the number ratio of (2× methyl acetate molecular weight) divided by the azeotropic concentration of the methyl acetate component in M by weight; and M is the flow rate of methyl acetate azeotrope product of step (5); (4) feeding the diacetate product of step (2) to a methanolysis zone along with methanol and methanolysis catalyst to produce a product mixture comprising methyl acetate, methanol, catalyst and polytetramethylene ether glycol; (5) feeding the product mixture of step (4) to a second stripping zone to produce products comprising methyl acetate azeotrope and polytetramethylene ether glycol; and (6) recovering the polytetramethylene ether glycol; wherein A is adjusted to control the number average molecular weight of the diacetate product of step (2) to be from about 300 to about 2300 dalton.

13. The process of claim 12 comprising steps (7) recovering the tetrahydrofuran from the first stripping zone of step (2), and (8) recycling the tetrahydrofuran recovered in step (7) to step (1).

14. The process of claim 12 wherein the polymerization effective conditions include a temperature of from about 0° C. to about 80° C.

15. The process of claim 14 wherein the polymerization effective conditions include a pressure from about 200 to about 800 mmHg.

16. The process of claim 12 wherein the catalyst of step (4) comprises an acid or base selected for the group consisting of H₂SO₄, HCl, alkali metal oxide, alkali metal hydroxide, alkali metal alkoxide, and combinations thereof.

17. An improved process for manufacturing polytetramethylene ether glycol comprising steps of (1) polymerizing tetrahydrofuran in the presence of an acylium ion precursor at polymerization effective conditions in a polymerization reaction zone to produce a first product mixture comprising tetrahydrofuran, acylium ion precursor, acid associated with the acylium ion precursor and diacetate of polytetramethylene ether glycol; (2) feeding the first product mixture of step (1) to a first stripping zone along with additional tetrahydrofuran to produce products comprising the diacetate and tetrahydrofuran; (3) determining the number average molecular weight of the diacetate product of step (2) by the formula: Mn=((A+B)×N)/A, wherein A is the net flow rate of acylium ion precursor to step (1), B is the sum of flow rates of tetrahydrofuran to step (1) and step (2), and N is the theoretical stoichiometric number defined as the molecular weight of acylium ion precursor per one mole of PTMEA stoichiometry; (4) feeding the diacetate product of step (2) to a methanolysis zone along with methanol and methanolysis catalyst to produce a second product mixture comprising methyl acetate, methanol, catalyst and polytetramethylene ether glycol; (5) feeding the second product mixture of step (4) to a second stripping zone to produce products comprising methyl acetate azeotrope and polytetramethylene ether glycol; and (6) recovering the polytetramethylene ether glycol; wherein A is adjusted to control the number average molecular weight of the diacetate product of step (2) to be from about 300 to about 2300 dalton.

18. The process of claim 17 wherein the number average molecular weight of the diacetate product of step (2) is controlled to be from about 800 to about 1900 dalton.

19. The process of claim 17 wherein the acylium ion precursor is selected from the group consisting of acetyl halides, carboxylic acid anhydrides and combinations thereof.

20. The process of claim 19 wherein the acylium ion precursor is acetic anhydride.

21. The process of claim 17 comprising steps (7) recovering the tetrahydrofuran from the first stripping zone of step (2), and (8) recycling the tetrahydrofuran recovered in step (7) to step (1).

22. The process of claim 17 wherein the polymerization effective conditions include a temperature of from about 0° C. to about 80° C.

23. The process of claim 22 wherein the polymerization effective conditions include a pressure from about 200 to about 800 mmHg.

24. The process of claim 22 in continuous mode wherein the polymerization effective conditions include a residence time from about 10 minutes to about 10 hours.

25. The process of claim 22 in batch mode wherein the polymerization effective conditions include a residence time from about 1 to about 24 hours.

26. The process of claim 22 wherein the acylium ion precursor is acetic anhydride and the acid associated with the acylium ion precursor is acetic acid.

27. The process of claim 17 wherein the catalyst of step (4) comprises an acid or base selected for the group consisting of H₂SO₄, HCl, alkali metal oxide, alkali metal hydroxide, alkali metal alkoxide, and combinations thereof.

28. An improved process for manufacturing polytetramethylene ether glycol comprising steps of (1) polymerizing tetrahydrofuran in the presence of an acetic anhydride at polymerization effective conditions in a polymerization reaction zone to produce a product mixture comprising tetrahydrofuran, acetic anhydride, acetic acid and diacetate of polytetramethylene ether glycol; (2) feeding the first product mixture of step (1) to a first stripping zone along with additional tetrahydrofuran to produce products comprising the diacetate and tetrahydrofuran; (3) determining the number average molecular weight of the diacetate product of step (2) by the formula: Mn=((A+B)×N)/A, wherein A is the net flow rate of acetic anhydride to step (1), B is the sum of flow rates of tetrahydrofuran to step (1) and step (2), and N is the theoretical stoichiometric number defined as the molecular weight of acylium ion precursor per one mole of PTMEA stoichiometry; (4) feeding the diacetate product of step (2) to a methanolysis zone along with methanol and methanolysis catalyst to produce a product mixture comprising methyl acetate, methanol, catalyst and polytetramethylene ether glycol; (5) feeding the product mixture of step (4) to a second stripping zone to produce products comprising methyl acetate azeotrope and polytetramethylene ether glycol; and (6) recovering the polytetramethylene ether glycol; wherein A is adjusted to control the number average molecular weight of the diacetate product of step (2) to be from about 300 to about 2300 dalton.

29. The process of claim 28 comprising steps (7) recovering the tetrahydrofuran from the first stripping zone of step (2), and (8) recycling the tetrahydrofuran recovered in step (7) to step (1).

30. The process of claim 28 wherein the polymerization effective conditions include a temperature of from about 0° C. to about 80° C.

31. The process of claim 30 wherein the polymerization effective conditions include a pressure from about 200 to about 800 mmHg.

32. The process of claim 28 wherein the catalyst of step (4) comprises an acid or base selected for the group consisting of H₂SO₄, HCl, alkali metal oxide, alkali metal hydroxide, alkali metal alkoxide, and combinations thereof.
